(19) United States
(12) Patent Application Publication
(10) Pub. No.: US 2016/0101698 A1
(43) Pub. Date: Apr. 14, 2016

(54) Method for Controlling the Regenerative Braking Torque of an Electric Machine of a Vehicle in an Open-Loop or Closed-Loop Manner in Accordance with Need, Said Electric Machine Operating in Generator Mode

(71) Applicant: Bayerische Motoren Werke Aktiengesellschaft, Muenchen (DE)

(72) Inventors: Johannes von GRUNDHERR, Muenchen (DE); Oliver SCHOERRIG, Neubiberg (DE)

(21) Appl. No.: 14/972,396

(22) Filed: Dec. 17, 2015

Related U.S. Application Data
(63) Continuation of application No. PCT/EP2014/060427, filed on May 21, 2014.

(30) Foreign Application Priority Data
Jun. 18, 2013 (DE) 10 2013 211 340.4

(51) Int. Cl. B60L 7/18; B60W 10/08; B60W 50/14; B60W 30/14; B60W 30/16; B60W 30/18; B60W 10/184

(52) U.S. Cl. CPC B60L 7/18; B60W 30/18127; B60W 10/08; B60W 10/184; B60W 30/143; B60W 30/16; B60W 50/14; B60W 2420/42; B60W 2520/10; B60W 2540/10; B60W 2550/142; B60W 2550/146; B60W 2550/22; B60W 2550/302; B60W 2550/308; B60W 2710/083; B60W 2720/10

(57) ABSTRACT

A method is provided for controlling regenerative braking torque, which is produced by an electric machine of a vehicle operating in generator mode in a coasting operation mode of the vehicle, in an open-loop or closed-loop manner in accordance with need. The method detects, on the basis of a specified algorithm, an imminent situation in which the speed of a vehicle should be reduced to a speed lower than the current speed. The method outputs a recommendation directed at the driver to release the accelerator when the expected occurrence of such a situation has been detected. If the driver has released the accelerator, the method controls the regenerative braking torque in an open-loop or closed-loop manner in such a way that the vehicle achieves the lower speed without actuation of the service brake when the situation occurs, or, if this cannot be achieved solely via the recuperation torque, maximizes the vehicle deceleration that can be produced by regenerative braking.

### CROSS REFERENCE TO RELATED APPLICATIONS

This application is a continuation of PCT International Application No. PCT/EP2014/060427, filed May 21, 2014, which claims priority under 35 U.S.C. §119 from German Patent Application No. 10 2013 211 340.4, filed Jun. 18, 2015, the entire disclosures of which are herein expressly incorporated by reference.

### BACKGROUND AND SUMMARY OF THE INVENTION

The present invention relates to a method for controlling the regenerative braking torque produced by an electrical machine of a vehicle operating in generator mode during coasting operation of the vehicle in an open-loop or closed-loop manner as needed.

In electric or hybrid vehicles, but also in conventional vehicles, kinetic energy of the vehicle is recovered in coasting operation via one or a plurality of electrical machines (electric drive machines or “alternators”) present in the vehicle, which is to say this energy is converted into electrical energy and buffered in an electrical energy store of the vehicle.

While the efficiency of electrical machines is comparatively high, a considerable portion of energy is lost both during the conversion of kinetic energy into electrical energy and during the (re)conversion of electrical energy into kinetic energy of the vehicle. Based on experience, only approximately 80% of the kinetic energy of the vehicle can be converted into electrical energy, and likewise only approximately 80% of the electrical energy can be converted back into kinetic energy of the vehicle.

It is the object of the invention to create a method for controlling an electrical machine that is present in the vehicle and being operated in generator mode in an open-loop or closed-loop manner as needed, by way of which “unnecessary energy conversion losses” are avoided to the greatest possible extent.

This and other objects are achieved by a method for controlling the regenerative braking torque produced by an electrical machine of a vehicle operating in generator mode during coasting operation of the vehicle in an open-loop or closed-loop manner as needed. The method detects, based on a predefined algorithm, an impending situation in which the speed of a vehicle should be reduced to a speed lower than the current speed. The method outputs a recommendation directed at the driver to release the accelerator when the occurrence of such a situation to be expected has been detected. If the driver has released the accelerator, the method controls the regenerative braking torque in an open-loop or closed-loop manner such that the vehicle achieves the lower speed without actuation of the service brake when the situation occurs or, if this cannot be achieved solely by the regenerative braking torque, maximizes the vehicle deceleration that can be produced by way of regenerative braking.

The starting point of the invention is the deliberation of controlling, in an open-loop or closed-loop manner, the “recovery power” or the generator torque (braking torque) exerted by the electrical machine during generator mode on the drive system of the vehicle in a situation-based, which is to say anticipatory, manner in such a way that an actuation of the service brake (such as a hydraulic brake) or unnecessarily strong regenerative braking, associated with unnecessarily premature renewed acceleration, is avoided.

The invention specifically relates to a method for controlling the regenerative braking torque, which is produced by an electrical machine of a vehicle operating in generator mode during coasting operation of the vehicle, in an open-loop or closed-loop manner as needed. In the case of an all-electric vehicle or a hybrid vehicle, the electrical machine can be a machine that can be used to generate the vehicle propulsion. In the case of a conventional vehicle powered solely by an internal combustion engine, the electrical machine may also be an “alternator” that is coupled to the internal combustion engine, for example via a belt drive, and exclusively performs the function of a generator.

By way of an evaluation algorithm, it is possible to detect situations in which the vehicle must be decelerated on an anticipatory basis, and to then control the regenerative braking torque in an open-loop or closed-loop manner as needed. Specifically, it is detected, based on a predefined algorithm, whether the speed of the vehicle should be reduced, or must be reduced, to a speed lower than the current speed on the upcoming driving route. The “anticipatory horizon” of this algorithm may range between several tens of meters to a few kilometers, for example.

If it is detected by way of the predefined algorithm that a situation is impending in which the vehicle speed should be reduced, or must be reduced, to a vehicle speed lower than the current one, a recommendation to “release the accelerator” is output to the driver. The recommendation can be output, for example, via a visual indicator, such as a control lamp, a display, a virtual display (so-called head-up display), via an acoustic signal generator, or also via a haptic signal generator (such as a vibrating component).

If the driver follows the recommendation and has released the accelerator, the regenerative braking torque is controlled (to the extent possible) in an open-loop or closed-loop manner in such a way that the vehicle achieves the lower speed without actuation of the service brake when the anticipatorily detected situation occurs.

If greater deceleration of the vehicle is required, which is to say if it is not possible to achieve the lower speed by regenerative braking alone by the time the particular situation occurs, it may be provided that the maximum possible regenerative braking power is used for braking, which is to say the vehicle deceleration that can be produced by way of recuperation is maximized. In the last case, the driver would then additionally have to use the service brake, which is subject to wear, to be able to decelerate the vehicle to the lower (target) speed.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a simplified flow chart illustrating the method for controlling the regenerative braking torque according to an embodiment of the invention.

### DETAILED DESCRIPTION OF THE DRAWING

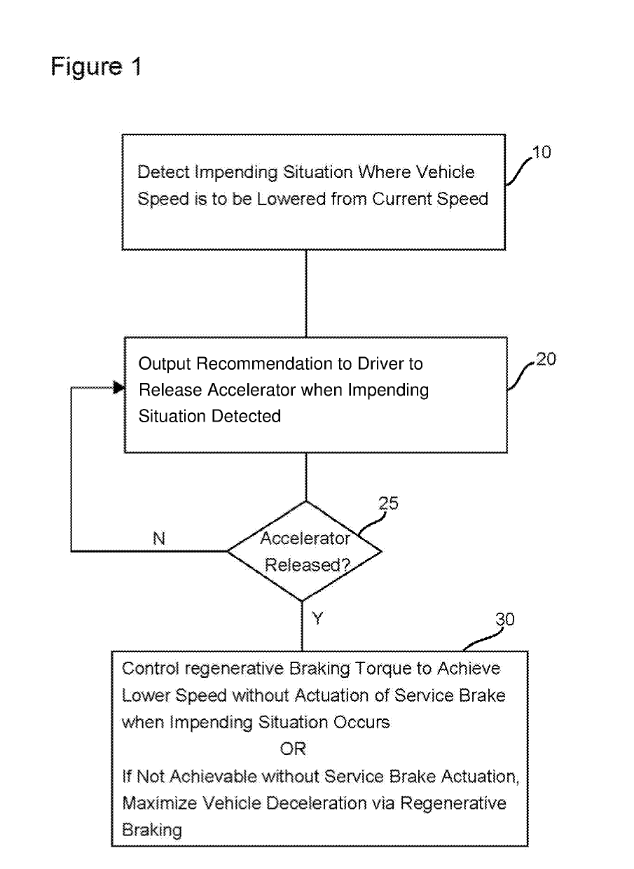

Referring to FIG. 1, the method detects, based on a predefined algorithm, whether the speed of the vehicle should be reduced, or must be reduced, to a speed lower than the current speed on the upcoming driving route (step 10). If it is detected by way of the predefined algorithm that a situation is impending in which the vehicle speed should be reduced, or must be reduced, to a vehicle speed lower than the current one, a recommendation to release the accelerator is output to the driver (step 20). If the driver follows the recommendation and releases the accelerator (step 25, yes), the regenerative braking torque is controlled (to the extent possible) in an open-loop or closed-loop manner such that the vehicle achieves the lower speed without actuation of the service brake when the anticipatorily detected situation occurs (step 30). If greater deceleration of the vehicle is required, which is to say if it is not possible to achieve the lower speed by regenerative braking alone by the time the particular situation occurs, then the maximum possible regenerative braking torque is used for braking (see also step 30).

According to a refinement of the invention, the recommendation directed at the driver recommends to completely release the accelerator. If the control member for acceleration is a pedal, the driver would therefore have to completely let go of the gas pedal. It shall be expressly pointed out that the invention is not limited to passenger cars or trucks, but could also be used in motorcycles, or in rail-borne vehicles, or other vehicles, for example.

It may be provided that the algorithm considers or evaluates a plurality of “pieces of ambient information.” In particular, it may be provided that the algorithm evaluates route information of the route to be traveled by the vehicle. As was already mentioned, the anticipatory horizon may range from several tens of meters (such as 50 meters) to a few kilometers (such as 1 to 2 km), for example.

Relevant route information can be provided by a navigation system, for example. The navigation system is preferably a navigation system that is permanently installed in the vehicle. If a destination has been programmed into the navigation system, route information may be taken directly from the programmed driving route.

As an alternative or in addition, individual pieces of route information can be picked up by way of a camera system of the vehicle and evaluated by an evaluation electronics system and fed to the algorithm.

The evaluation of data supplied by a navigation system and/or by a camera system of the vehicle and/or by other sensors of the vehicle, such as ultrasonic, radar or LIDAR sensors, allows certain information to be taken into consideration, for example:
upcoming speed limits,
upcoming curves,
radii of upcoming curves,
the signal state of a stop light located on the upcoming route,
the position of stop lines (such as in front of stop lights),
traffic signs,
the distance from a preceding vehicle,
the speed of a preceding vehicle,
the relative speed with respect to a preceding vehicle, and/or
the relative acceleration with respect to a preceding vehicle.

Moreover, the algorithm can take into consideration whether a downhill grade section or an uphill grade or a substantially flat section lies ahead.

For example, if a vehicle traveling at a speed of 80 km/h is approaching a route section at which a speed limit of 60 km/h, for example, is in effect, the driver may be informed about this 100 or 200 meters before the speed limit, for example, along with the recommendation to let off the accelerator pedal.

If the driver follows the recommendation and releases the pedal, an electrical machine present in the vehicle is controlled in an open-loop or closed-loop manner in such a way that the regenerative braking torque (braking torque) produced by the electrical machine regeneratively decelerates the vehicle (to the extent possible) to the allowed maximum speed by the time the route section in which the speed limit is in effect is reached. According to the invention, the regenerative braking torque is therefore produced as needed, whereby the efficiency of the vehicle is improved.

The longer it takes for the driver to follow a recommendation to let off the accelerator pedal, the greater is the regenerative braking power applied by open-loop or closed-loop control. For example, it may be provided that braking takes place at 70% of the regenerative braking torque that can be applied when a desired speed is to be reached after 100 meters, or at the maximum achievable regenerative braking torque when a desired speed is to be reached after 70 meters.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling regenerative braking torque produced by an electrical machine of a vehicle in an open-loop or closed-loop manner as needed, the electrical machine being operated in a generator mode during coasting operation of the vehicle, the method comprising the acts of:
detecting, via a predefined algorithm, an impending situation in which a speed of the vehicle should be reduced to a speed lower than a current speed;
outputting a recommendation directed at a driver of the vehicle to release an accelerator of the vehicle when the impending situation is detected;
after the driver releases the accelerator, controlling the regenerative braking torque in an open-loop or closed-loop manner such that the vehicle achieves the speed lower than the current speed without actuation of a service brake when the impending situation occurs, or
if the speed lower than the current speed cannot be achieved solely by controlling the regenerative braking torque, then maximizing deceleration of the vehicle via the regenerative braking.

2. The method according to claim 1, wherein the recommendation directed at the driver is a recommendation to completely release the accelerator.

3. The method according to claim 2, wherein the predefined algorithm is configured to evaluation route information of a route to be traveled by the vehicle.

4. The method according to claim 1, wherein the predefined algorithm is configured to evaluation route information of a route to be traveled by the vehicle.

5. The method according to claim 3, wherein individual pieces of route information are provided for use by the predefined algorithm by a navigation system of the vehicle.

6. The method according to claim 5, wherein the individual pieces of route information are provided based on a target route programmed into the navigation system of the vehicle.

7. The method according to claim 3, wherein the individual pieces of route information are acquired via a camera system installed in the vehicle and evaluated via an evaluation electronics system, wherein the evaluated individual pieces of the route information are provided for use by the predefined algorithm.

8. The method according to claim 1, wherein the predefined algorithm factors into account upcoming speed limits.

9. The method according to claim 1, wherein the predefined algorithm factors into account upcoming curves and/or radii of upcoming curves.

10. The method according to claim 1, wherein the predefined algorithm factors into account whether a downhill grade section, an uphill grade section, or a substantially flat grade section lies ahead of the vehicle.

11. The method according to claim 1, wherein the predefined algorithm factors into account a signal state of a stop light located on an upcoming route of the vehicle.

12. The method according to claim 1, wherein the predefined algorithm factors into account a position of a stop line or a distance from a stop line in front of a stop light.

13. The method according to claim 1, wherein the predefined algorithm factors into account a distance from defined traffic signs located on an upcoming route of the vehicle.

14. The method according to claim 1, wherein the predefined algorithm factors into account a distance from a preceding vehicle.

15. The method according to claim 1, wherein the predefined algorithm factors into account a speed of a preceding vehicle.

16. The method according to claim 1, wherein the predefined algorithm factors into account a relative speed with respect to a preceding vehicle.

17. The method according to claim 1, wherein the predefined algorithm factors into account a relative acceleration with respect to a preceding vehicle.
